(19) United States
(12) Patent Application Publication
(10) Pub. No.: US 2010/0265499 A1
(43) Pub. Date: Oct. 21, 2010

(54) PROGRAMMABLE RAMAN TRANSDUCER

(76) Inventors: Keith Carron, Centennial, WY (US); Mark Watson, Laramie, WY (US); Shane Butler, Laramie, WY (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/376,831

(22) PCT Filed: Aug. 7, 2007
(86) PCT No.: PCT/US07/17559

§ 371 Date: Jun. 17, 2010

Related U.S. Application Data
(60) Provisional application No. 60/835,937, filed on Aug. 7, 2006.

(51) Int. Cl. G01J 3/44

(52) U.S. Cl. 356/301

(57) ABSTRACT

A programmable Raman transducer is disclosed for detecting the presence or absence of a preselected compound in a sample. The transducer, in a preferred embodiment, includes a laser source for generating laser light for illuminating the sample. Collector optics, absent a spatial filter, are used for collecting Raman-scattered light from the sample. A detector generates spectral data from the Raman-scattered light, and a digital processor compares the spectral data to a database of spectral data on selected compounds, including the preselected compound to generate a binary signal indicating presence or absence of the preselected compound.

This application claims priority pursuant to 35 U.S.C. § 119(e) to United States Patent Application No. 60/835,937, filed Aug. 7, 2006, which is hereby incorporated herein by reference in its entirety.

### BACKGROUND OF THE INVENTION

The present invention relates generally to instruments for analyzing a sample and, more specifically, to a programmable Raman transducer used as a small, portable spectrometer.

Currently, Raman measurements of a sample are made with a spectrometer, that is; an instrument used for measuring wavelengths of light. The goal of the Raman measurement is to acquire a spectrum composed of the intensity and energy of the Raman scattered photons from the sample. The spectrum can be used to determine physical properties of the sample, such as component concentration or component composition. Component concentration can be determined by the intensity of the Raman features. Component composition can be determined by the spectral energy associated with the Raman features.

This invention relates to methods required to produce a Raman transducer. Transducers are small devices that convert a physical quantity into a signal. A transducer is a device that is actuated by power from one system and supplies power usually in another form to a second system. A Raman transducer changes photons of light energy from molecularly scattered radiation (physical quantity) into a digital value (electric signal) that designates the presence of a material or amount of material present.

### SUMMARY OF INVENTION

The invention described herein is a programmable Raman transducer that introduces design concepts that transform a Raman spectrometer into a Raman transducer. The Raman transducer will enable applications such as counterfeit detection, brand security, low-cost assay readers, low-cost material identification systems, and detection of chemical and biological weapons, and medical diagnostics. The requirement is a very low-cost, very small, battery powered system that could be placed on a belt or carried in a pocket.

### BRIEF DESCRIPTION OF THE DRAWINGS

FIG. 1 is a chart of a typical output from a Raman spectrometer.

FIG. 2 is an illustration of a typical, prior art Raman spectrometer.

FIG. 3 is an illustration of a Raman transducer of a preferred embodiment of the present invention.

FIG. 4 is an illustration of an alternative preferred embodiment of the present invention.

FIG. 5 is an illustration of the operation of an algorithm for use with the present invention, showing a spectrum, its derivative, and removal of regions with no information.

FIG. 6 is a schematic of an example an expanded laser beam version of the programmable Raman transducer of the present invention.

FIG. 7 is an illustration of a preferred embodiment of the present invention with the laser blocking material as the spacer.

FIG. 8 is an illustration of a sample Raman spectra acquired with a transducer of the present invention.

### DETAILED DESCRIPTION OF A PREFERRED EMBODIMENT

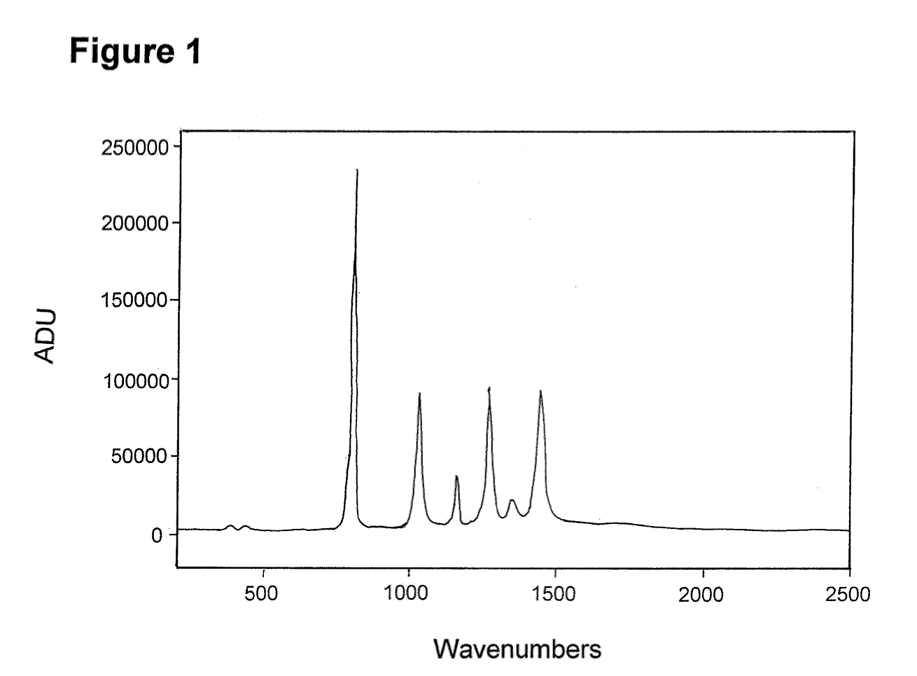

FIG. 1 shows a typical output from a Raman spectrometer. The y-axis shows the intensity of the Raman features. The intensity is linearly related to the concentration of the Raman scatterer, that is, the target sample or unknown. The x-axis is the energy of the Raman scattered light. It is most often plotted in the units of wavenumbers (cm⁻¹). The position of Raman features is often tabulated for determination of the chemical structure of the scatterer.

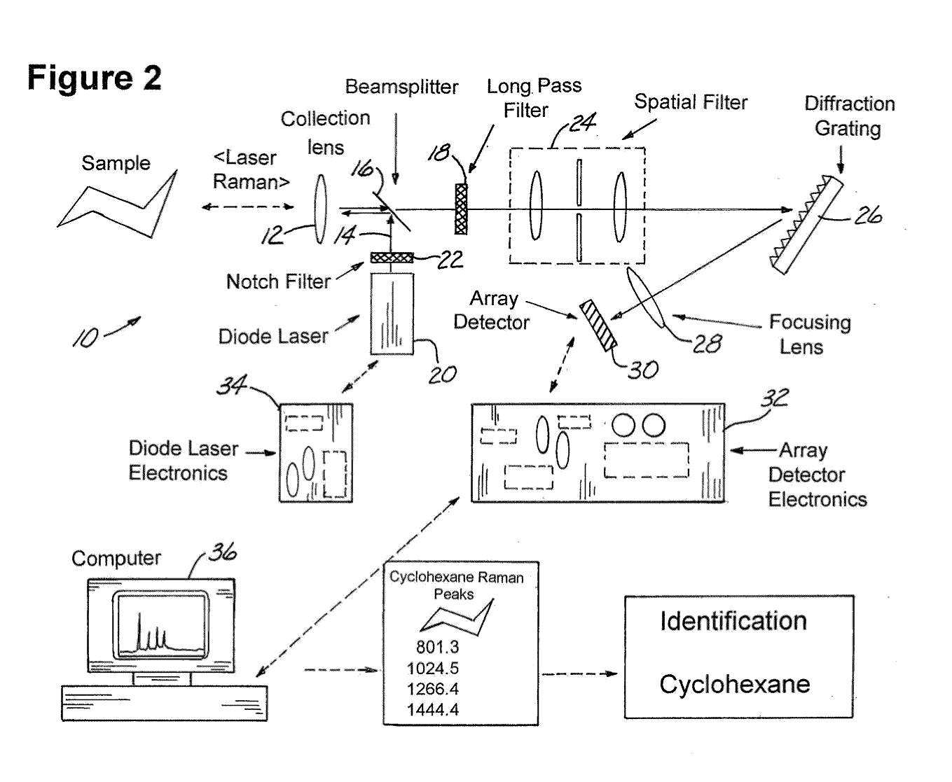

Illustrated in FIG. 2, generally at 10, is a typical Raman spectrometer design. Moving from the top left, features that are common to Raman spectrometers are a collection lens 12 which, in this case, focuses the laser excitation to a small focal spot and collects the Raman scattered radiation from that small focused spot. Since the laser beam going into the collection lens 12 is collimated it will focus to a point one focal length from the lens 12. Conversely, the Raman scattering originating from this focal spot will be transformed into a collimated beam by the collection lens 12. This collimated beam 14 passes through a beamsplitter 16 designed to transmit the Raman scattered wavelengths. The beamsplitter 16 is also designed to reflect the laser wavelength. This type of optical component is designated a dichroic (two color) element. This element functions by constructive and destructive interference of radiation passing through the element. Because interference is affected by the angle on incidence it is necessary that the light passing though it, or reflected by it, is collimated. This condition is met by the collimated laser beam 14 and the collimated Raman scattered light. Next the Raman scattered light passes through a long pass filter 18. This element removes the majority of the laser radiation reflected or scattered back with the Raman scattering. If not removed the laser radiation backscattered or reflected into the spectrograph 10 can produce a large interference with the Raman scattered radiation.

The laser diode 20 is shown emitting radiation in a direction orthogonal to the collected Raman radiation. The dichroic beamsplitter 16 is chosen to preferentially reflect the wavelength of the laser. Lasers tend to emit radiation at wavelengths other than their laser wavelength. For example, diode lasers emit an envelope of spontaneously emitted light around the laser wavelength. Therefore, it is usually necessary to use a notch filter 22 (or what is often called a clean-up filter) to remove the other components of the laser emission. If they are not removed they will add a continuous background to the Raman spectrum or may cause spurious lines that can be confused with Raman scattering.

The next component is a spatial filter 24. This is a key element to current Raman spectrograph designs. It is also called a slit (rectangular, adjustable slits), aperture (usually a fixed circular aperture), or a fiber optic (essentially a fixed circular aperture). The optics of current Raman spectrographs can be divided into “output optics” and “diffractive optics”. The output optics and the diffractive optics are always separated by a spatial filter. On the output optics side the goal is to produce a small laser spot and to image that small spot onto the aperture of the spatial filter. On the diffractive optics side the goal is to image the aperture onto the detector. The size of the aperture determines the spectral resolution and can affect the amount of light that transfers between the output optics and the diffractive optics.

After the spatial filter, the Raman scattered radiation is once again collimated. It impinges on a diffraction grating 26 that produces optical orders of diffracted light coming off the grating at an angle which is dependent on the wavelength. These wavelengths are collected by the focusing lens 28 and are focused to spots which are the size of the aperture in the spatial filter onto the detector 30. Most often the detector 30 consists of an array of optical transducers which convert the light into an electrical signal. When the electrical signal produced by each element of the array detector 30 is plot across the plane of diffraction, a Raman spectrum as shown in FIG. 1 is produced.

Peripheral to the optical components every spectrograph contains printed circuit cards (PC cards) that contain the electrical components needed to read the signal from the array 32 and to power the laser diode 34. These peripheral PC cards also communicate to a computer 36 which is used to display the data and to perform mathematical manipulations on the data.

### EXAMPLE 1

### Portable Raman Transducer

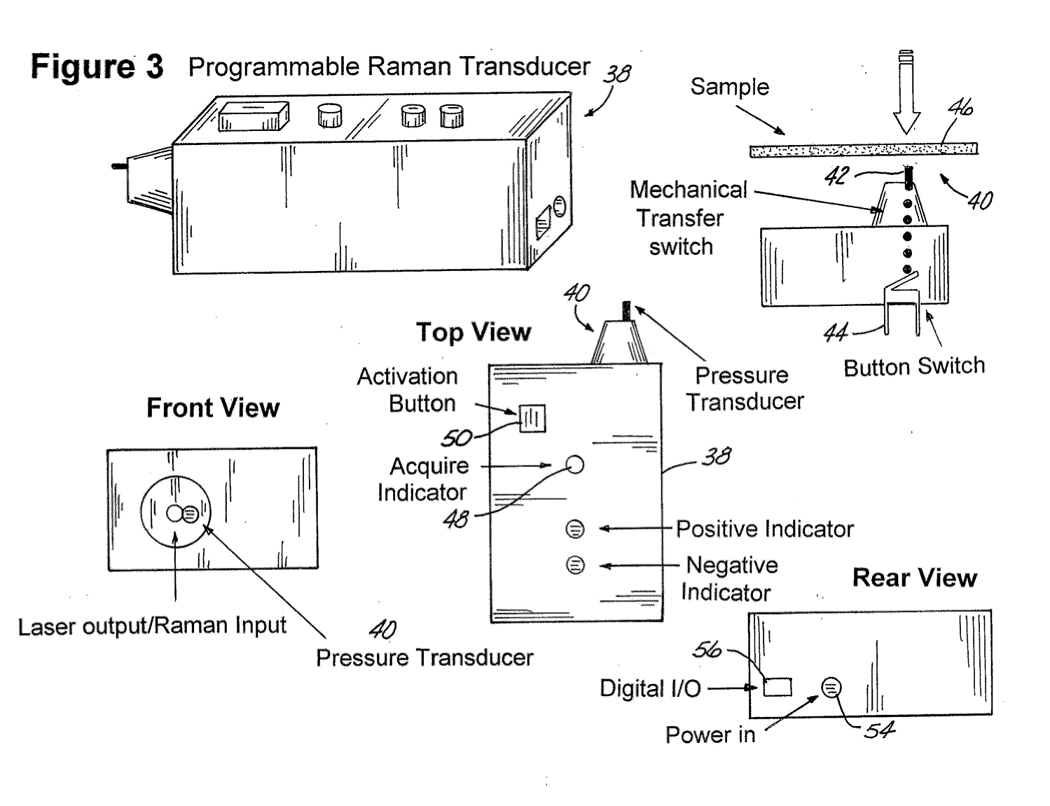

FIG. 3 illustrates a preferred embodiment of this invention. The Raman transducer 38 consists of a small enclosure with an output piece that contains a mechanical alignment device 40, such as a pressure transducer. The mechanical alignment device 40 may, for example, comprise a small metal shaft 42 that contacts to the button switch 44 on the PC board inside the device 38. In a preferred embodiment, the sample 46 pushes the shaft 42 in to actuate the, button switch 44. When the switch 44 is actuated the laser turns on, shining through the laser output 52 and the acquire indicator 48 is lighted. This tells the user that an acquisition is taking place. This embodiment has two significant roles. First, it provides the user with a visual or audible indication that proper alignment has been attained. Second, it provides a safety interlock that only turns the laser on when the mechanical alignment 40 device is activated. The position of the mechanical alignment device 40 is sufficiently close to the laser output aperture 52 that an accidental pressing of the device by an appendage will also block the beam with the appendage. Accordingly, whenever a putative sample, that is either an actual sample or an accidental contact of the mechanical alignment with something other than an actual sample, such as an appendage, the laser will impinge on the putative sample and be blocked from shining on an unintended target. The top view of the device shows an activate button 50 which is pressed and turns on the laser and electronics for a short period (1 minute), during which the measurement will occur if the mechanical alignment device 40 is activated. This increases battery life and is another step toward laser safety. It requires the activation button 50 to be pressed and the mechanical alignment device 40 to be pressed before the laser turns on. In its simplest form, the Raman transducer 38 has a positive and negative indicator. In a further embodiment, multiple indicators are used to increase the number of materials that can be identified or a text screen is used to describe a concentration or name the material identified. FIG. 3 shows the back of the device 38 which contains a charging port 54 for battery charging and a USB port 56 for programming and alignment with an external computer.

### EXAMPLE 2

### Alternative Portable Raman Transducer

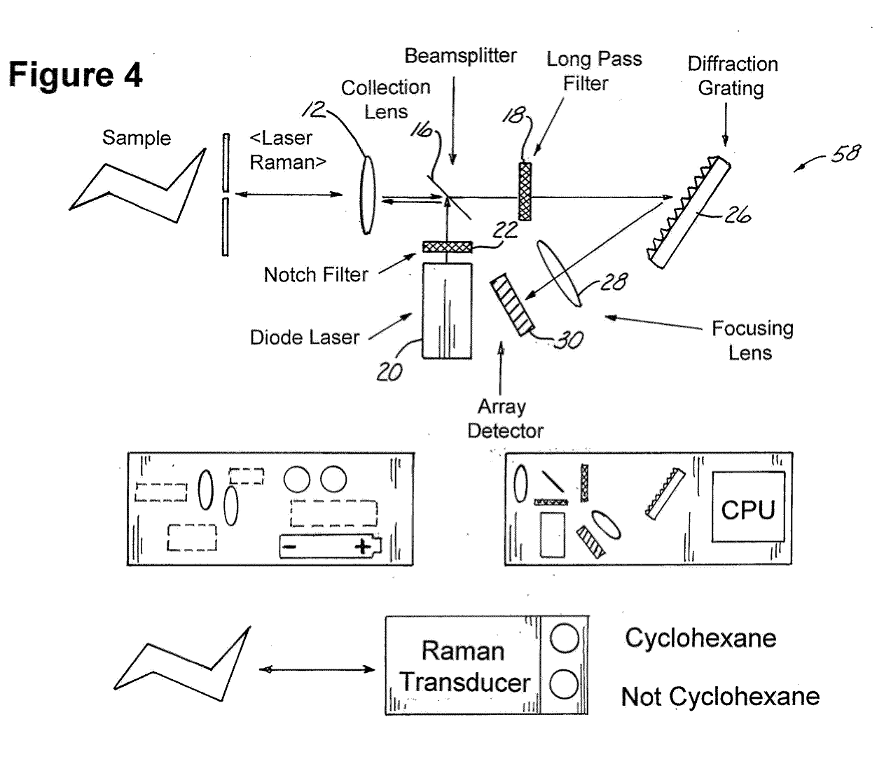

Illustrated in FIG. 4, generally at 58, is an alternative preferred embodiment of the present invention. While all current Raman spectrometers follow the design concept of “output optics” separated from “diffractive optics”, the design shown in FIG. 4 integrates the components into a single unit and eliminates the spatial filter. The key to this device is that the Raman scattering must evolve from a small spot on a surface. Simply removing the spatial filter from a Raman spectrograph will not produce this effect. In addition to removing the spatial filter, it is essential that the Raman scattering is collected from a spot one focal length from the collection lens 12. In this preferred embodiment of the present invention, similarly to the device illustrated in FIG. 3, a mechanical device will be placed on the sampling tip which when depressed will trip a switch that allows the laser to turn on. For laser safety consideration, the mechanical device will function only when a second “activate” button has been pressed. For purposes of cost and size reduction, the Raman transducer is fabricated directly onto a PC card which contains the detector readout electronics, laser diode control circuitry, and computation components. The signal in this case is a visible and/or audible yes/no for material identification. An indicator will also state when a measurement is being made. The PC board of Raman transducer 58 has an additional beneficial property of a thermal coefficient of expansion that is one-half of that of aluminum. Aluminum is a common light weight metal used to machine optical benches. The laser in FIG. 4 is a temperature stabilized—frequency stabilized laser. For example, a laser with a volume Bragg grating output coupler will maintain a single frequency output. This is essential for matching an unknown spectrum with a library spectrum.

Traditional methods for material identification are peak lookup tables in books, lookup table of peaks in computer memory and comparison of the results of a peak finding algorithm on the spectrum of the unknown or more mathematically intensive methods that use algorithms based on the concept of correlation. For example, the latter is used in the hand-held Raman spectrometer, the RespondeR™ (Smiths Group PLC, London, England). The RespondeR contains complete spectra of thousands of materials and searches those spectra to identify an unknown based on a mathematically calculated correlation. While the RespondeR might be considered an intermediate between a large Raman spectrograph and a Raman transducer, it still uses the design of output optics and diffractive optics.

### EXAMPLE 3

### Algorithm for Data Analysis

The present invention uses an algorithm which greatly reduces the amount of time and digital memory required to identify a material. The algorithm recognizes that many of spectral frequencies in a Raman spectrum do not contain information. The method described by this invention creates a compressed data set that only contains information useful for identification. This method greatly decreases the digital memory requirements and greatly increases the search speed. The following describes a method for manual library entries.

In collecting raw data, it is preferred that at least about 600 data points (words) are used. The data should be calibrated to insure that each programmable Raman transducer of the present invention is equivalent. A probable calibration is

[CA]=A +B[RD]+C[RD]²

[RD]=raw data

[CA]=calibrated array.

A sample library file structure is:

[LIB]: [indentifier:byte, index:word, length:byte, library data[index:index+length] :word]

In a preferred embodiment, one peak is used define a library element. The library will contain entries for each element. The entries will have an identifier that is a number, for example 0-255, an index which defines where that peak begins in the calibrated data, and a length that defines how many data points make up a peak. Initial research indicates that peaks are about 50 data points wide. If an 8 bit ADC is used then these can be bytes; if wa 12 bit ADC is used, these will be words.

Library search algorithm

A correlation search routine is used in a preferred embodiment. This routine calculates a correlation between the [CA] and the [LIB] using:

Corr =([αCA_{mc}]·[αLIB_{mc} ])²/([αCA_{mc}]·[αCA_{mc}]*[αLIB_{mc}]·[αLIB_{mc}])

[αCA_{mc}]=[αCA]−(ΣαCAᵢ)/(length−5))

αCAᵢ=CAᵢ−CAᵢ₋₅

The correlation method provides a result from 0 to 1. It is susceptible to baseline variations. Therefore a derivative [αCA] is used with a 5 point gap. The method produces the greatest differentiation when the data arrays are mean centered. Mean centering requires subtraction of the mean from the data array.

In a preferred embodiment, the first byte of the library is read and used as the identifier. The next two bytes provide the start index for the peak. The next byte provides how many array elements make up the peak. The next arrays elements are the library data. There should be “length” number of elements, where length is given by the fourth byte of the library array for any given library component. A correlation of 0.9 or better could, for example, be used to indicate a positive.

It is also possible to automate this process such that the Raman transducer could be pointed at a material and queried to program. It then automatically acquires a spectrum, takes a derivative, normalize between -1 and 1, and finds locations where the peaks are. A threshold of peaks >0.5 and <-0.5 could, for example, be used to select only prominent Raman features. The location and data associated with these peaks could be used for a correlation match as described above.

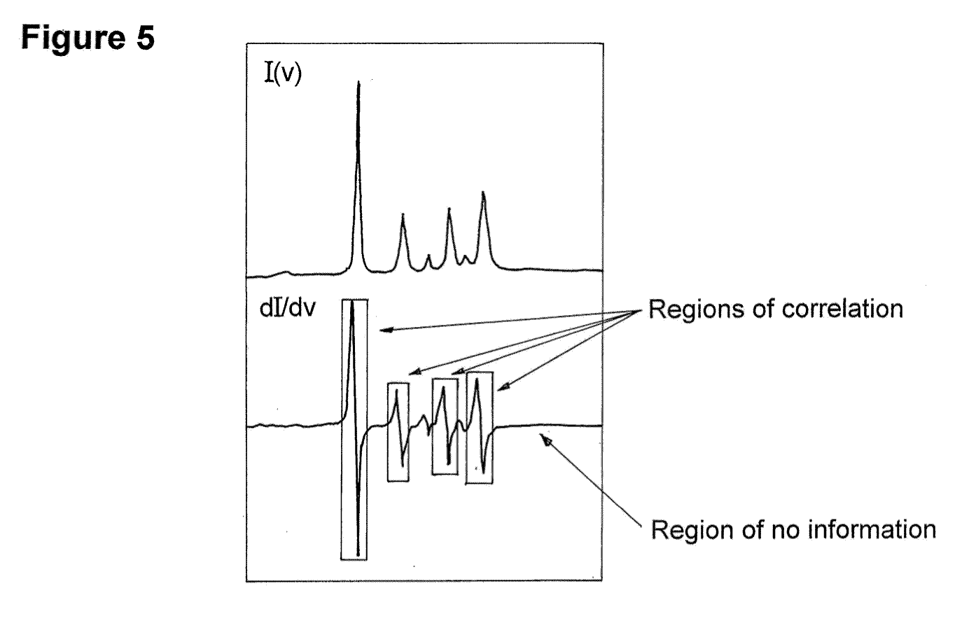

When multiple peaks are used the individual correlations will be added and divided by the number of peaks used. In this way a value of 1 will always be attained for a perfect correlation, regardless of the number of peaks measured. FIG. 5 illustrates the concept of a spectrum, its derivative, and removal of regions with no information.

### EXAMPLE 4

### Portable Raman Transducer with Increased Laser Spot Size

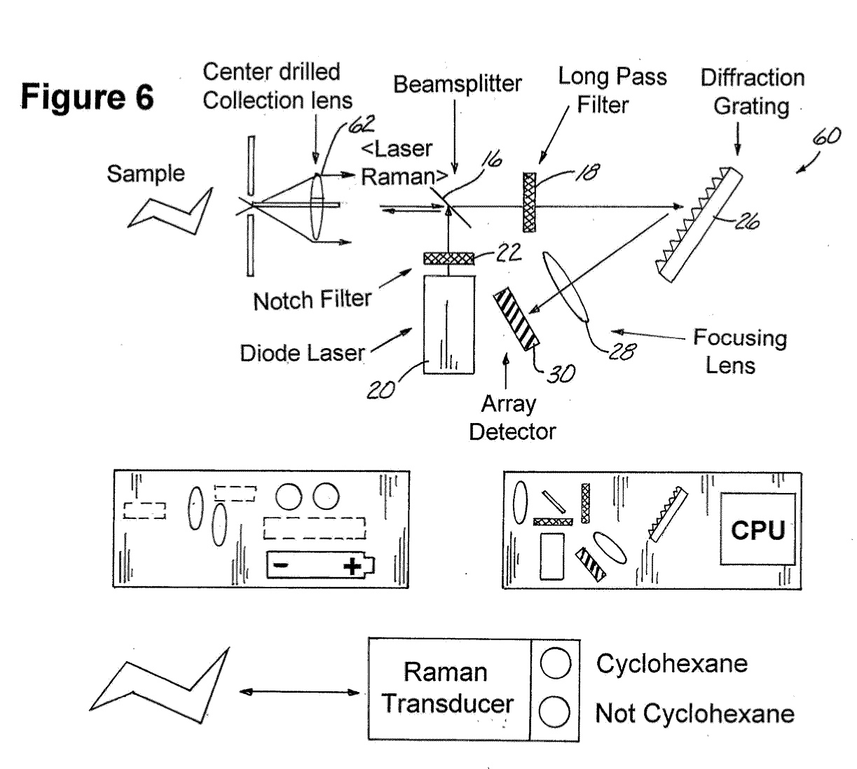

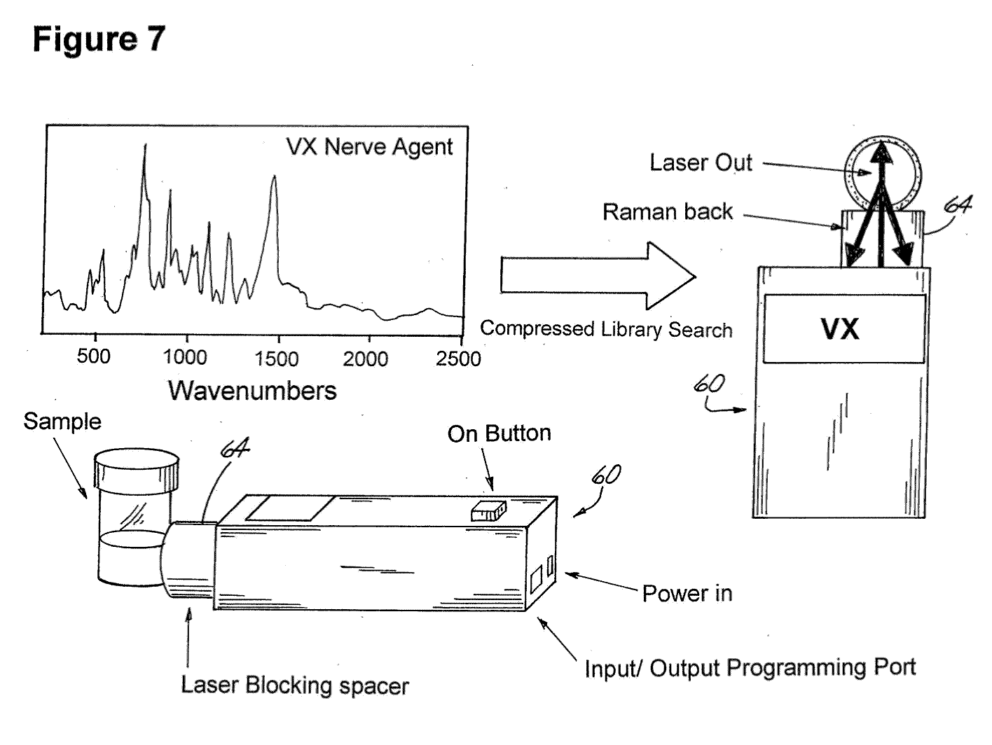

FIG. 6 illustrates an alternative embodiment 60 of the present invention comprising a method to increase the laser spot size to provide an average over a larger surface area of the sample. This may be achieved with a center drilled output lens 62 that does not focus the laser, but the lens collects the Raman scattered light. This design will keep the Raman scattering collection large, but it will keep the laser beam averaged over a large area. As with the previous design a crucial component of this invention is the sampling procedure. It will be important to maintain the proper distance between sample and collection lens 62 to collect the largest amount of Raman scattered light. The spacer 64 may consist of a blocking material that prevents the escape of laser radiation, but allows the user to view the container. FIG. 7 shows a view of this device with the laser blocking material as the spacer 64. Transducers of the present invention may be very small compared to existing Raman transducers. A preferred embodiment of the present invention is approximately five inches long and three inches wide.

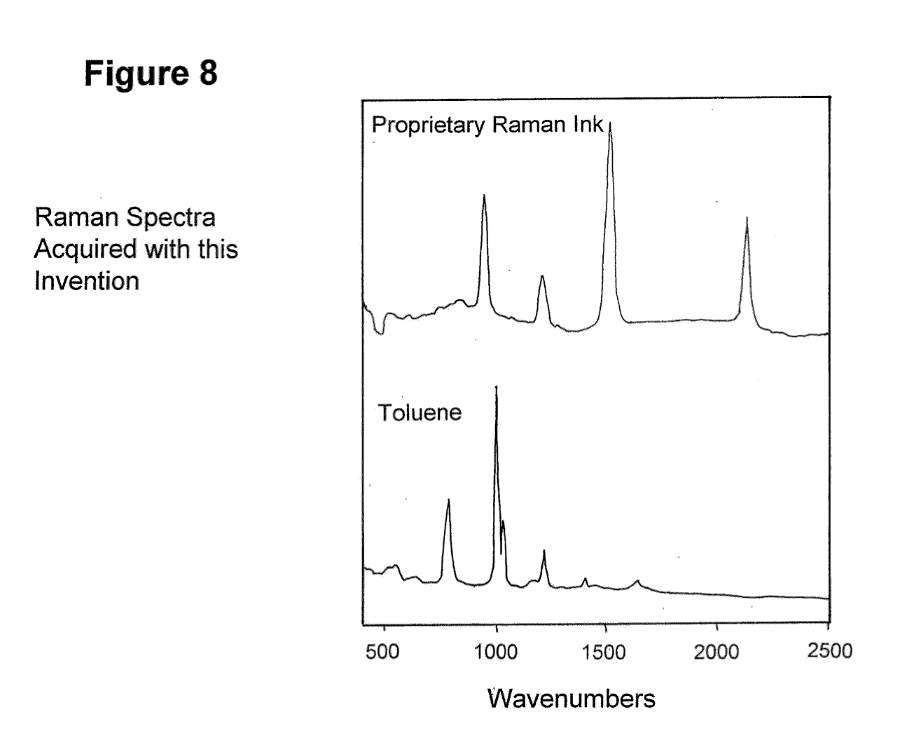

FIG. 8 shows a sample Raman spectra acquired with a transducer of the present invention. The top spectrum is indicative of the brand security application. This is a Raman spectrum of a proprietary ink printed on a sheet of paper. The transducer will be used to identify this ink and generates a binary (yes/no) signal, for example show a green indicator for a positive identification or red for a counterfeit. This will be used to brand a product with a Raman tag that is very difficult to synthesize or reproduce. The bottom spectrum of toluene shows how the transducer can identify an unknown liquid. The narrow, multiple bands in a Raman spectrum make this transducer ideal for material identification.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

We claim:

1. A Raman transducer for detecting the presence or absence of a preselected compound in a sample, comprising:
(a) a stabilized laser source for generating laser light for illuminating the sample;
(b) optics to simultaneously transmit the laser radiation to the sample and collect the Raman scattered light from the sample;
(c) a detector for generating spectral data from the Raman-scattered light; and
(d) a digital processor for comparing the spectral data to a database of spectral data on selected compounds, including the preselected compound to generate a signal indicating presence or absence of the preselected compound.

2. A Raman transducer as defined in claim 1, wherein the optics are free of a spatial filter.

3. A Raman transducer as defined in claim 1, further comprising a sensor for detecting the presence of a putative sample located adjacent the laser source so that the laser source impinges on the putative sample when the sensor detects the presence of the putative sample.

4. A Raman transducer as defined in claim 3, wherein the sensor comprises a pressure-activated switch.

5. A Raman transducer as defined in claim 4, wherein the sensor comprises a mechanical pressure-activated switch.

6. A Raman transducer as defined in claim 1, further comprising a shield opaque to the laser imposed between the laser source and a sample to be analyzed by the transducer.

7. A Raman transducer as defined in claim 1, wherein the sample is between 0.001 and 1000 meters from the transducer.

8. A Raman transducer for detecting the presence or absence of a preselected compound in a sample, comprising:
(a) an enclosure; and
(b) a printed circuit board optical bench mounted in the enclosure on which is supported
(i) a stabilized laser source for generating laser light for illuminating the sample,
(ii) optics to simultaneously transmit the laser radiation to the sample and collect the Raman scattered light from the sample,
(iii) a detector for generating spectral data from the Raman-scattered light, and
(iv) a digital processor for comparing the spectral data to a database of spectral data on selected compounds, including the preselected compound to generate a signal indicating presence or absence of the preselected compound

9. A method for analyzing a Raman spectrum of a sample, comprising the steps of:
(a) identifying start and end points of a peak of the spectrum;
(b) taking the derivative of the peak to generate an array;
(c) conducting a correlation between the array and a library of arrays of known materials; and
(d) generating a signal responsive to the sample using digital computational methods.
